(19) United States
(12) Patent Application Publication
(10) Pub. No.: US 2025/0038653 A1
(43) Pub. Date: Jan. 30, 2025

(54) POWER DELIVERY FAST CHARGING CONTROL CIRCUIT AND POWER DELIVERY FAST CHARGING CONTROL METHOD

(71) Applicant: Moso Power Supply Technology Co., Ltd., Shenzhen City (CN)

(72) Inventor: Wenhang LU, Shenzhen City (CN)

(73) Assignee: Moso Power Supply Technology Co., Ltd., Shenzhen City (CN)

(21) Appl. No.: 18/760,604

(22) Filed: Jul. 1, 2024

(30) Foreign Application Priority Data
Jul. 25, 2023 (CN) 202310922723.6

(51) Int. Cl. H02M 1/42; H02J 7/00

(52) U.S. Cl. CPC H02M 1/4225; H02J 7/0071; H02J 2207/20

(57) ABSTRACT

A power delivery (PD) fast charging control circuit and a PD fast charging control method are provided in the disclosure. The PD fast charging control circuit includes an isolated direction current (DC) to DC (DC/DC) conversion module, a multi-channel buck module, a pass-through mode control module, and a feedback voltage control module. The isolated DC/DC conversion module is configured to output a DC voltage. The multi-channel buck module is configured to buck the DC voltage. The pass-through mode control module is configured to generate a control signal according to a charging load connected, send the control signal to the feedback voltage control module, and control an operating mode of the multi-channel buck module. The operating mode includes a normal mode and a pass-through mode. The feedback voltage control module is configured to control a voltage value of the DC voltage according to the control signal received.

### CROSS-REFERENCE TO RELATED APPLICATION

This application claims priority under 35 U.S.C. § 119(a) to and the benefit of Chinese Patent Application No. 202310922723.6, filed Jul. 25, 2023, the entire disclosure of which is incorporated herein by reference.

### TECHNICAL FIELD

The disclosure relates to the technical field of fast charging, and in particular, to a power delivery (PD) fast charging control circuit and a PD fast charging control method.

### BACKGROUND

Currently, a PD fast charging source will exhibit significant heat generation and low power conversion efficiency when outputting power via multiple ports.

### SUMMARY

In view of above, embodiments of the disclosure provide a PD fast charging control circuit and a PD fast charging control method to solve a problem of low power conversion efficiency of a PD fast charging source.

A power delivery (PD) fast charging control circuit is provided in the embodiments of the disclosure. The PD fast charging control circuit includes an isolated direction current (DC) to DC (DC/DC) conversion module, a multi-channel buck module, a pass-through mode control module, and a feedback voltage control module. The isolated DC/DC conversion module is configured to output a DC voltage. The multi-channel buck module is configured to buck the DC voltage. The pass-through mode control module is configured to generate a control signal according to a charging load connected, send the control signal to the feedback voltage control module, and control an operating mode of the multi-channel buck module. The operating mode includes a normal mode and a pass-through mode. The feedback voltage control module is configured to control a voltage value of the DC voltage according to the control signal received.

According to the foregoing aspect and any one of possible embodiments, an embodiment is further provided. The pass-through mode control module is configured to acquire voltage requirement information of the charging load in response to connection of the charging load. The pass-through mode control module is configured to generate the control signal according to the voltage requirement information and send the control signal to the feedback voltage control module. The feedback voltage control module is configured to control, according to the voltage requirement information in the control signal, DC conversion of the isolated DC/DC conversion module to set the voltage value of the DC voltage outputted to be the same as a voltage value of the voltage requirement information or set the voltage value of the DC voltage to be a preset minimum output voltage value.

According to the foregoing aspect and any one of possible embodiments, an embodiment is further provided. The pass-through mode control module is configured to send a first operating mode switching command to the multi-channel buck module to enable the multi-channel buck module to operate in the pass-through mode, when the voltage value of the DC voltage outputted is set to be the same as the voltage value of the voltage requirement information. The pass-through mode control module is configured to send a second operating mode switching command to the multi-channel buck module to enable the multi-channel buck module to operate in the normal mode, when the voltage value of the DC voltage is set to be the preset minimum output voltage value and the preset minimum output voltage value is greater than the voltage value of the voltage requirement information.

According to the foregoing aspect and any one of possible embodiments, an embodiment is further provided. The feedback voltage control module is configured to determine a target output voltage value of the isolated DC/DC conversion module according to the voltage requirement information in the control signal, and the isolated DC/DC conversion module is configured to reset conversion logic of DC conversion according to the target output voltage value to enable that the isolated DC/DC conversion module is able to output the target output voltage value according to the conversion logic.

According to the foregoing aspect and any one of possible embodiments, an embodiment is further provided. The PD fast charging control circuit further includes a DC input module. The DC input module includes an alternating current (AC) input filtering module, a rectification output module, and a power factor correction boost module. The AC input filtering module is configured to filter an AC that is inputted to the AC input filtering module. The rectification output module is configured to rectify the AC that is filtered. The power factor correction boost module is configured to output an original DC voltage to the isolated DC/DC conversion module, where the original DC voltage is greater than a voltage outputted by the isolated DC/DC conversion module.

In a second aspect, a PD fast charging control method is further provided in the embodiments of the disclosure. The PD fast charging control method includes the following. A pass-through mode control module generates a control signal according to a charging load connected, sends the control signal to a feedback voltage control module, and determines an operating mode of a multi-channel buck module. The operating mode includes a normal mode and a pass-through mode. The feedback voltage control module controls a voltage value of a DC voltage outputted by an isolated direct current (DC) to DC (DC/DC) conversion module according to the control signal received. The isolated DC/DC conversion module powers the charging load directly when an operating mode of the multi-channel buck module is the pass-through mode. The multi-channel buck module bucks the DC voltage to power the charging load when the operating mode of the multi-channel buck module is the normal mode.

According to the foregoing aspect and any one of possible embodiments, an embodiment is further provided. The pass-through mode control module generates the control signal according to the charging load connected and sends the control signal to the feedback voltage control module as follows. The pass-through mode control module acquires voltage requirement information of the charging load according to the charging load connected. The pass-through mode control module generates the control signal according to the voltage requirement information. The pass-through mode control module sends the control signal to the feedback voltage control module.

According to the foregoing aspect and any one of possible embodiments, an embodiment is further provided. The feedback voltage control module controls the voltage value of the DC voltage outputted by the isolated DC/DC conversion module according to the control signal received as follows. The feedback voltage control module controls a DC conversion of the isolated DC/DC conversion module according to the voltage requirement information in the control signal to set the voltage value of the DC voltage outputted to be the same as a voltage value of the voltage requirement information or set the voltage value of the DC voltage to be a preset minimum output voltage value.

According to the foregoing aspect and any one of possible embodiments, an embodiment is further provided. The operating mode of the multi-channel buck module is determined as follows. The pass-through mode control module sends a first operating mode switching command to the multi-channel buck module to enable the multi-channel buck module to operate in the pass-through mode, when the voltage value of the DC voltage output is set to be the same as the voltage value of the voltage requirement information. The pass-through mode control module sends a second operating mode switching command to the multi-channel buck module to enable the multi-channel buck module to operate in the normal mode, when the voltage value of the DC voltage is set to be the preset minimum output voltage value and the minimum output voltage value is greater than the voltage value of the voltage requirement information.

According to the foregoing aspect and any one of possible embodiments, an embodiment is further provided. The feedback voltage control module controls the DC conversion of the isolated DC/DC conversion module according to the voltage requirement information in the control signal as follows. The feedback voltage control module determines a target output voltage value of the isolated DC/DC conversion module according to the voltage requirement information in the control signal, so that the isolated DC/DC conversion module is able to reset conversion logic of DC conversion according to the target output voltage value to enable that the isolated DC/DC conversion module is able to output the target output voltage value according to the conversion logic.

The embodiments of the disclosure provide the PD fast charging control circuit. The PD fast charging control circuit includes the isolated DC/DC conversion module, the multi-channel buck module, the pass-through mode control module, and the feedback voltage control module. Specifically, the pass-through mode control module is configured to generate the control signal according to the charging load connected and send the control signal to the feedback voltage control module. The feedback voltage control module is configured to control the voltage value of the DC voltage outputted by the isolated DC/DC conversion module according to the control signal received. The pass-through mode control module is configured to determine the operating mode of the multi-channel buck module. The isolated DC/DC conversion module is configured to power the charging load directly when the operating mode of the multi-channel buck module is the pass-through mode. The multi-channel buck module is configured to buck the DC voltage to power the charging load when the operating mode of the multi-channel buck module is the normal mode. In this way, the voltage value of the DC voltage outputted by the isolated DC/DC conversion module can be correspondingly adjusted according to the charging load connected, so that the voltage value of the DC voltage outputted by the isolated DC/DC conversion module is the same as or similar to a voltage value required by the charging load. In addition, the multi-channel buck module can operate in the pass-through mode, thereby significantly improving the power conversion efficiency of the PD fast charging source.

### BRIEF DESCRIPTION OF THE DRAWINGS

To describe technical solutions in embodiments of the disclosure more clearly, the following briefly introduces the accompanying drawings required for describing the embodiments or the related art. Apparently, the accompanying drawings in the following description only illustrate some embodiments of the disclosure. Those of ordinary skill in the art may also obtain other drawings based on these accompanying drawings without creative efforts.

FIG. 1 is a schematic circuit topology diagram of a PD fast charging control circuit according to an embodiment of the disclosure.

FIG. 2 is a control data flow diagram of a PD fast charging control circuit according to an embodiment of the disclosure.

FIG. 3 is a schematic diagram of a PD fast charging control method according to an embodiment of the disclosure.

### DETAILED DESCRIPTION

In order to better understand technical solutions of the disclosure, the embodiments of the disclosure will be described in detail below in conjunction with the accompanying drawings.

It is understood that the embodiments described herein are merely part of rather than all of the embodiments of the disclosure. All other embodiments obtained by a person of ordinary skill in the art based on the embodiments of the disclosure without creative efforts shall fall within the scope of protection of the disclosure.

The terms used in the embodiments of the disclosure are for the purpose of describing particular embodiments only and is not intended to be limiting of the disclosure. As used in the embodiments of the disclosure and the appended claims, the singular forms “a”, “an”, and “the” are intended to include plural forms as well, unless the context clearly indicates otherwise.

It is understood that, the term “and/or” referred to herein only describes an association relationship between associated objects, which indicates that there can be three relationships, for example, A and/or B can indicate A alone, both A and B, or B alone. In addition, the character “/” referred to herein generally indicates that the associated objects are in an “or” relationship.

It is understood that, although terms such as “first”, “second”, and “third” may be used in the embodiments of the disclosure to describe a preset range, the preset range should not be limited to these terms. These terms are only used to distinguish the preset ranges from each other. For example, the first preset range may also be referred to as a second preset range, and similarly, the second preset range may also be referred to as the first preset range, without departing from the scope of the embodiments of the disclosure.

Depending on the context, the word “if” referred to herein may be construed as “when”, “during”, “in response to determining”, or “in response to detecting”. Similarly, depending on the context, phrases such as “if it is determined” or “if (a stated condition or event) is detected” may be construed as “upon determining”, “in response to determining”, “upon detecting (a stated condition or event)”, or “in response to detecting (a stated condition or event)”.

The disclosure provides a PD fast charging control circuit. The PD fast charging control circuit includes an isolated direction current (DC) to DC (DC/DC) conversion module, a multi-channel buck module, a pass-through mode control module, and a feedback voltage control module.

In one embodiment, the disclosure achieves the ultra-high efficient conversion of the PD fast charging source through the pass-through mode control module and the feedback voltage control module. It may be understood that, in an operating mode of a traditional PD fast charging source, an isolated DC/DC conversion module is configured to output a fixed voltage of about 29 V, and a multi-channel buck module is configured to buck and output based on the output voltage of 29 V to satisfy voltage requirements of different charging loads. An output voltage of the multi-channel buck module has six values, such as 28 V, 20 V, 15 V, 12 V, 9 V, and 5 V. However, this operating mode just causes low efficiency conversion of the traditional PD fast charging source. For example, in a case where the output voltage of the isolated DC/DC conversion module is 29 V, and the multi-channel buck module will perform buck conversion on the output voltage of 29 V to output a voltage of 20 V, then the power conversion efficiency is very low. In a case where the output voltage of the isolated DC/DC conversion module is 29 V, and the multi-channel buck module will perform buck conversion on the output voltage of 29 V to output a voltage of 28 V, then the power conversion efficiency is acceptable. However, in practical applications, it cannot be guaranteed that charging loads connected are all require a voltage of 28 V. The diversity in voltage requirements of the charging loads is common in practical applications. Therefore, in the operating mode of the traditional PD fast charging source, when multiple interfaces are connected to the charging loads, the traditional PD fast charging source is prone to heating issues, indicating a problem of relatively low power conversion efficiency.

The disclosure provides an operating mode of a novel PD fast charging source. Specifically, a charging load is first considered. The pass-through mode control module is configured to generate a control signal upon connection of the charging load to a PD fast charging control circuit, and to determine an output voltage and an operating mode of a multi-branch buck module according to the control signal that is generated according to the charging load. It can be understood that the charging load is a key for activating a control mode of the PD fast charging control circuit. In the disclosure, with regard to actual voltage requirements of various charging loads, an internal voltage output of the PD fast charging control circuit can be controlled, so that loss of electric energy can be reduced during the process from energy output to energy input to the charging load, achieving non-differential power conversion enhancement for various types of charging loads. In one embodiment, the feedback voltage control module may receive the control signal sent by the pass-through mode control module, and control a voltage value of a DC voltage outputted by the isolated DC/DC conversion module according to the control signal, so that the voltage value of the DC voltage outputted by the isolated DC/DC conversion module can meet an actual voltage requirement of the charging load. In this way, the voltage value of the DC voltage can accurately match the actual voltage requirement of each different charging load, thereby supporting ultra-high power conversion efficiency, and avoiding excessive heat generation even if the PD fast charging control circuit is connected to charging loads through multiple ports. It may be noted that, the pass-through mode control module may also control the operating mode of the multi-channel buck module. For example, the pass-through mode control module may control the multi-channel buck module to operate in a normal mode or a pass-through mode. In the normal mode, the multi-channel buck module is configured to normally perform buck conversion on the DC voltage. In the pass-through mode, the multi-channel buck module can be regarded as a short circuit, allowing the isolated DC/DC conversion module to directly output the DC voltage to the charging load. In the pass-through mode, by eliminating allocation and consumption processes of the multi-channel buck module for electric energy, the power conversion efficiency of the PD fast charging source can be significantly improved.

Further, the pass-through mode control module is configured to acquire voltage requirement information of the charging load in response to connection of the charging load. The pass-through mode control module is configured to generate the control signal according to the voltage requirement information and send the control signal to the feedback voltage control module. The feedback voltage control module is configured to control, according to the voltage requirement information in the control signal, DC conversion of the isolated DC/DC conversion module to set the voltage value of the DC voltage outputted to be the same as a voltage value of the voltage requirement information or set the voltage value of the DC voltage to be a preset minimum output voltage value.

In one embodiment, the PD fast charging control circuit may first acquire the voltage requirement information of the charging load upon connection of the charging load to the PD fast charging control circuit. For example, the voltage requirement information of a charging load 1 may be a voltage of 28 V, the voltage requirement information of a charging load 2 may be a voltage of 12 V, and the voltage requirement information of a charging load 3 may be a voltage of 20 V. Upon determination of the voltage requirement information of the charging load, the pass-through mode control module may generate the control signal and send the control signal to the feedback voltage control module. The control signal may be sent in the form of an electrical parameter. Alternatively, the control signal may be sent in the form of a program instruction. A carrier form of the control signal is not limited herein. The control signal may be understood as a signal that triggers the isolated DC/DC conversion module to change a current operating mode of the isolated DC/DC conversion module. It can be understood that, in a traditional mode of the isolated DC/DC conversion module, the isolated DC/DC conversion module is configured to output a fixed voltage of about 29V. However, in the disclosure, the PD fast charging control circuit is configured to automatically generate a corresponding control signal upon connection of the charging load to the PD fast charging control circuit, and to change the output voltage of the isolated DC/DC conversion module according to the control signal, so that a current output voltage logic and the current mode of the isolated DC/DC conversion module can be changed accordingly. Specifically, the isolated DC/DC conversion module is configured to control DC conversion according to the control signal received, so that the voltage value of the DC voltage outputted can be set to be the same as the voltage value of the voltage requirement information, or be set to be the preset minimum output voltage value. For example, when a voltage of 28 V needs to be outputted by the multi-channel buck module, the pass-through mode control module may send the control signal to the feedback voltage control module to control the isolated DC/DC conversion module to output a voltage of 28 V, and at the same time, the multi-channel buck module is controlled to operate in the pass-through mode through the pass-through mode control module. When a voltage of 20 V needs to be outputted by the multi-channel buck module, the pass-through mode control module may send the control signal to the feedback voltage control module to control the isolated DC/DC conversion module to output a voltage of 28 V, and at the same time, the multi-channel buck module is controlled to operate in the pass-through mode through the pass-through mode control module. Further, when a voltage of 5 V, a voltage of 9 V, a voltage of 12 V, and a voltage of 15 V need to be outputted by the multi-channel buck module, the pass-through mode control module may send the control signal to the feedback voltage control module to control the isolated DC/DC conversion module to output a voltage of 20 V, and then the pass-through mode is deactivated, a system is in a normal traditional buck operating mode, and at this point, the multi-channel buck module can realize normal buck output. It can be seen that, in a case where the output voltage is greater than 20 V, in order to achieve high-efficiency conversion, the isolated DC/DC conversion module may be controlled to output a voltage value the same as the voltage value of the voltage requirement information of the charging load. In a case where the output voltage is not greater than 20V, the efficiency conversion requirement is not so high, and a traditional buck operating mode can still be employed for charging, thereby reducing the setup cost of the PD fast charging control circuit, and still providing high power conversion efficiency.

Further, the pass-through mode control module is configured to send a first operating mode switching command to the multi-channel buck module to enable the multi-channel buck module to operate in the pass-through mode, when the voltage value of the DC voltage outputted is set to be the same as the voltage value of the voltage requirement information. The pass-through mode control module is configured to send a second operating mode switching command to the multi-channel buck module to enable the multi-channel buck module to operate in the normal mode, when the voltage value of the DC voltage is set to be the preset minimum output voltage value and the preset minimum output voltage value is greater than the voltage value of the voltage requirement information.

In an embodiment, the operating mode of the multi-channel buck module is switchable, allowing for the selection of the optimal operating mode to power a charging load on different charging scenarios. Specifically, the switching of the operating mode of the multi-channel buck module may be performed through the first operating mode switching command and the second operating mode switching command. It may be understood that, the multi-channel buck module can protect multiple charging paths, that is, support the simultaneous connection of at least one charging load for charging. For example, in a case where two charging loads are simultaneously connected, if a voltage required by a first charging load is 28 V, an operating mode of a charging path of the first charging load may be the pass-through mode, and if a voltage required by the second charging load is 15 V, an operating mode of a charging path of the second charging load may be the normal mode.

Further, the isolated DC/DC conversion module may also be configured to perform multiple-path output and single-path output. In a case where the isolated DC/DC conversion module supports the multiple-path output, the isolated DC/DC conversion module may output different voltages to charging paths of different charging loads according to voltage requirements of different charging loads, and the pass-through mode is preferentially selected as the operating mode of the multi-channel buck module. In a case where the isolated DC/DC conversion module supports only the single-path output, the isolated DC/DC conversion module may perform output according to the highest voltage requirement of the charging load connected. For example, if the highest voltage requirement of the charging load is a voltage of 28 V, the isolated DC/DC conversion module may set the output voltage to be 28 V. The charging path for the charging load with a voltage requirement of 28 V may adopt the pass-through mode of the multi-channel buck module, while the charging paths of other charging loads may adopt the normal mode.

In some implementations of the disclosure, the isolated DC/DC conversion module may be implemented as an isolated DC/DC converter. The multi-channel buck module may be implemented as a multi-channel buck converter. The pass-through mode control module may be implemented as a pass-through mode controller. The feedback voltage control module may be implemented as a feedback voltage controller.

Further, the feedback voltage control module is configured to determine a target output voltage value of the isolated DC/DC conversion module according to the voltage requirement information in the control signal, and the isolated DC/DC conversion module is configured to reset conversion logic of DC conversion according to the target output voltage value to enable that the isolated DC/DC conversion module is able to output the target output voltage value according to the conversion logic.

In an embodiment, during a specific control of the output voltage of the isolated DC/DC conversion module, the target output voltage value of the isolated DC/DC conversion module may be determined first according to the control signal. Then, the conversion logic of DC conversion of the isolated DC/DC conversion module may be reset according to the target output voltage value of the isolated DC/DC conversion module. Alternatively, a current conversion logic of DC conversion may be replaced with a preset conversion logic of DC conversion, so that the isolated DC/DC conversion module can accurately output the target output voltage value.

Further, the PD fast charging control circuit further includes a DC input module. The DC input module includes an alternating current (AC) input filtering module, a rectification output module, and a power factor correction boost module.

The AC input filtering module is configured to filter an AC that is inputted to the AC input filtering module.

The rectification output module is configured to rectify the AC that is filtered.

The power factor correction boost module is configured to output an original DC voltage to the isolated DC/DC conversion module. The original DC voltage is greater than a voltage outputted by the isolated DC/DC conversion module.

In an embodiment, the PD fast charging control circuit may further include other functional modules, such as the AC input filtering module, the rectification output module, and the power factor correction boost module. These functional modules contribute to converting an external AC voltage into the original DC voltage for the isolated DC/DC conversion module of the PD fast charging control circuit. This conversion establishes the technical prerequisites for controlling the isolated DC/DC conversion module to achieve arbitrary voltage transformations.

In some implementations of the disclosure, the DC input module may be implemented as a DC input circuit. The AC input filtering module may be implemented as an AC input filter. The rectification output module may be implemented as an output rectifier. The power factor correction boost module may be implemented as a power factor correction boost converter.

Further, related circuits of the traditional PD fast charging source do not include the pass-through mode control module and the feedback voltage control module. In the practical design and production of the PD fast charging control circuit of the disclosure, the disclosure achieves improvements upon the traditional PD fast charging source. The pass-through mode control module and the feedback voltage control module are provided for the isolated DC/DC conversion module and the multi-channel buck module, so that the pass-through mode control module and the feedback voltage control module can operate with the pass-through mode control module and feedback voltage control module to allow the PD fast charging control circuit in the above embodiments to achieve interaction and control functions. Specifically, logic control circuits or logic control chips corresponding to the pass-through mode control module and the feedback voltage control module can be added into the related circuits of the traditional PD fast charging source, thereby achieving a significantly enhanced power conversion efficiency of the PD fast charging source in the PD fast charging control circuit of the disclosure.

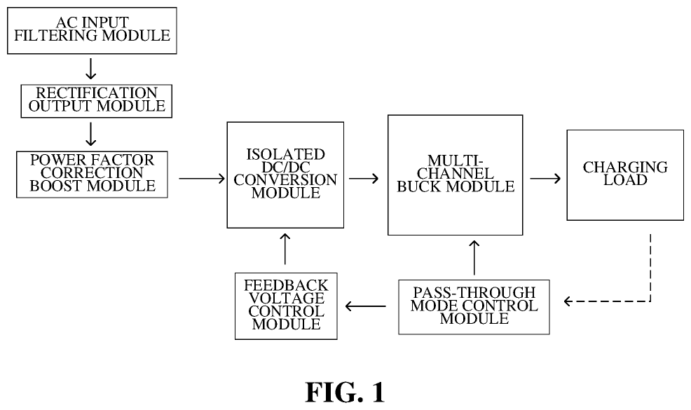

FIG. 1 is a schematic circuit topology diagram of a PD fast charging control circuit according to an embodiment of the disclosure.

As illustrated in FIG. 1, the PD fast charging control circuit includes the AC input filtering module, the rectification output module, a power factor correction boost module, the isolated DC/DC conversion module, the multi-channel buck module, the pass-through mode control module, the feedback voltage control module, and a charging load.

The AC input filtering module is configured to filter an AC that is inputted to the AC input filtering module. The rectification output module is configured to rectify the AC that is filtered. The power factor correction boost module is configured to output the original DC voltage to the isolated DC/DC conversion module, where the original DC voltage is greater than the voltage outputted by the isolated DC/DC conversion module. The AC input filtering module, the rectification output module, and the power factor correction boost module can be combined to form the DC input module for providing the original DC voltage for the isolated DC/DC conversion module.

The isolated DC/DC conversion module is configured to output the DC voltage. The multi-channel buck module is configured to buck the DC voltage. The pass-through mode control module is configured to generate the control signal according to the charging load connected, send the control signal to the feedback voltage control module, and control the operating mode of the multi-channel buck module. The operating mode includes a normal mode and a pass-through mode. The feedback voltage control module is configured to control the voltage value of the DC voltage according to the control signal received. Information interaction among the various modules can be seen from FIG. 1. It can be seen that the pass-through mode control module and the feedback voltage control module will control the isolated DC/DC conversion module and the multi-channel buck module in response to connection of the charging load, thereby achieving the high conversion efficiency of the PD fast charging control circuit in the above embodiments of the disclosure.

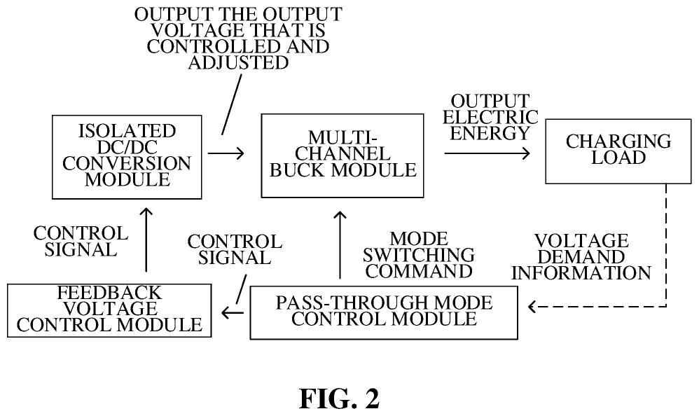

FIG. 2 is a control data flow diagram of the PD fast charging control circuit according to an embodiment of the disclosure.

As illustrated in FIG. 2, the charging load may send the voltage demand information to the pass-through mode control module upon connection of the charging load. The pass-through mode control module may generate the control signal to the feedback voltage control module, and send a mode switching command to control the operating mode of the multi-channel buck module. The feedback voltage control module may control the output voltage of the isolated DC/DC conversion module according to the control signal upon receiving the control signal. Then, the isolated DC/DC conversion module may output the output voltage that is controlled and adjusted, and output electric energy according to the operating mode of the multi-channel buck module to power the charging load.

In the embodiments of the disclosure, the PD fast charging control circuit is provided. The PD fast charging control circuit includes the isolated DC/DC conversion module, the multi-channel buck module, the pass-through mode control module, and the feedback voltage control module. Specifically, the pass-through mode control module is configured to generate the control signal according to the charging load connected and send the control signal to the feedback voltage control module. The feedback voltage control module is configured to control the voltage value of the DC voltage outputted by the isolated DC/DC conversion module according to the control signal received. The pass-through mode control module is configured to determine the operating mode of the multi-channel buck module. The isolated DC/DC conversion module is configured to power the charging load directly when the operating mode of the multi-channel buck module is the pass-through mode. The multi-channel buck module is configured to buck the DC voltage to power the charging load when the operating mode of the multi-channel buck module is the normal mode. In this way, the voltage value of the DC voltage outputted by the isolated DC/DC conversion module can be correspondingly adjusted according to the charging load connected, so that the voltage value of the DC voltage outputted by the isolated DC/DC conversion module is the same as or similar to a voltage value required by the charging load. In addition, the multi-channel buck module can operate in the pass-through mode, thereby significantly improving the power conversion efficiency of the PD fast charging source.

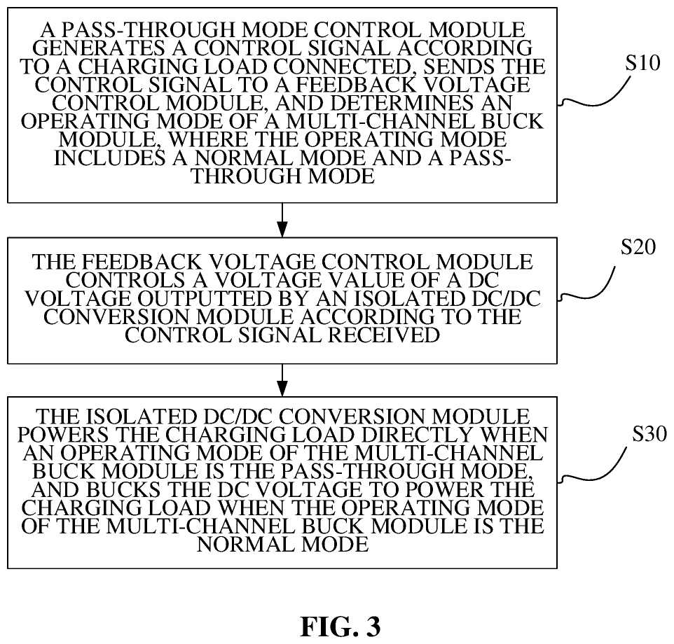

FIG. 3 is a schematic diagram of the PD fast charging control method according to an embodiment of the disclosure.

As illustrated in FIG. 3, the embodiments of the disclosure further provide a PD fast charging control method. The PD fast charging control method includes the following.

At S10, a pass-through mode control module generates a control signal according to a charging load connected, sends the control signal to a feedback voltage control module, and determines an operating mode of a multi-channel buck module, where the operating mode includes a normal mode and a pass-through mode.

At S20, the feedback voltage control module controls a voltage value of a DC voltage outputted by an isolated DC/DC conversion module according to the control signal received.

At S30, the isolated DC/DC conversion module powers the charging load directly when an operating mode of the multi-channel buck module is the pass-through mode, and bucks the DC voltage to power the charging load when the operating mode of the multi-channel buck module is the normal mode.

Further, the pass-through mode control module generates the control signal according to the charging load connected and sends the control signal to the feedback voltage control module as follows.

The pass-through mode control module acquires voltage requirement information of the charging load according to the charging load connected, generates the control signal according to the voltage requirement information, and sends the control signal to the feedback voltage control module.

Further, the feedback voltage control module controls the voltage value of the DC voltage outputted by the isolated DC/DC conversion module according to the control signal received as follows.

The feedback voltage control module controls a DC conversion of the isolated DC/DC conversion module according to the voltage requirement information in the control signal to set the voltage value of the DC voltage outputted to be the same as a voltage value of the voltage requirement information or set the voltage value of the DC voltage to be a preset minimum output voltage value.

Further, the operating mode of the multi-channel buck module is determined as follows.

The pass-through mode control module sends a first operating mode switching command to the multi-channel buck module to enable the multi-channel buck module to operate in the pass-through mode, when the voltage value of the DC voltage output is set to be the same as the voltage value of the voltage requirement information. The pass-through mode control module sends a second operating mode switching command to the multi-channel buck module to enable the multi-channel buck module to operate in the normal mode, when the voltage value of the DC voltage is set to be the preset minimum output voltage value and the minimum output voltage value is greater than the voltage value of the voltage requirement information.

Further, the feedback voltage control module controls the DC conversion of the isolated DC/DC conversion module according to the voltage requirement information in the control signal as follows.

The feedback voltage control module determines a target output voltage value of the isolated DC/DC conversion module according to the voltage requirement information in the control signal, so that the isolated DC/DC conversion module resets conversion logic of DC conversion according to the target output voltage value to enable that the isolated DC/DC conversion module is able to output the target output voltage value according to the conversion logic.

In the embodiments of the disclosure, the pass-through mode control module is configured to generate the control signal according to the charging load connected and send the control signal to the feedback voltage control module. The feedback voltage control module is configured to control the voltage value of the DC voltage outputted by the isolated DC/DC conversion module according to the control signal received, and the pass-through mode control module is configured to determine the operating mode of the multi-channel buck module. In this way, the voltage value of the DC voltage outputted by the isolated DC/DC conversion module can be correspondingly adjusted according to the charging load connected, so that the voltage value of the DC voltage outputted by the isolated DC/DC conversion module is the same as or similar to a voltage value required by the charging load. In addition, the multi-channel buck module can operate in the pass-through mode, thereby significantly improving the power conversion efficiency of the PD fast charging source.

It is noted that, in the disclosure, functions of the pass-through mode control module and feedback voltage control module of the disclosure may also be achieved through a combination module integrated with the pass-through mode control module and the feedback voltage control module. That is, the PD fast charging control method of the disclosure or the PD fast charging control circuit of the disclosure can be implemented through the combination module. The combination module may be considered to be an implementable manner of the disclosure, and shall fall within the scope of protection of the disclosure.

It may be understood that solutions and products implemented based on the PD fast charging control circuit shall fall within the scope of protection of the disclosure.

It may be clearly understood by a person skilled in the art that, for the sake of the convenience and simplicity in description, delineation of the foregoing functional units and modules is only used as an illustrative example. In actual applications, the foregoing functions may be allocated to and implemented by different functional units and modules according to requirements. That is, an internal structure of an apparatus may be divided into different functional units or modules to implement all or part of functions described above.

The above embodiments are merely intended to describe the technical solutions of the disclosure rather than limit the disclosure. Although the disclosure is described in detail with reference to the foregoing embodiments, persons of ordinary skill in the art should understand that they may still make modifications to the technical solutions described in the foregoing embodiments or make equivalent replacements to some technical features thereof. These modifications or replacements do not make the essence of the corresponding technical solutions depart from the spirit and scope of the technical solutions of the embodiments of the disclosure, and shall all fall within the scope of protection of the disclosure.

What is claimed is:

1. A power delivery (PD) fast charging control circuit, comprising:
an isolated direction current (DC) to DC (DC/DC) conversion module configured to output a DC voltage;
a multi-channel buck module configured to buck the DC voltage;
a pass-through mode control module configured to generate a control signal according to a charging load connected, send the control signal to a feedback voltage control module, and control an operating mode of the multi-channel buck module, the operating mode comprising a normal mode and a pass-through mode; and
the feedback voltage control module configured to control a voltage value of the DC voltage according to the control signal received.

2. The PD fast charging control circuit of claim 1, wherein the pass-through mode control module is configured to acquire voltage requirement information of the charging load in response to connection of the charging load, the pass-through mode control module is configured to generate the control signal according to the voltage requirement information and send the control signal to the feedback voltage control module, and the feedback voltage control module is configured to control, according to the voltage requirement information in the control signal, DC conversion of the isolated DC/DC conversion module to set the voltage value of the DC voltage outputted to be the same as a voltage value of the voltage requirement information or set the voltage value of the DC voltage to be a preset minimum output voltage value.

3. The PD fast charging control circuit of claim 2, wherein
the pass-through mode control module is configured to send a first operating mode switching command to the multi-channel buck module to enable the multi-channel buck module to operate in the pass-through mode, when the voltage value of the DC voltage outputted is set to be the same as the voltage value of the voltage requirement information; and
the pass-through mode control module is configured to send a second operating mode switching command to the multi-channel buck module to enable the multi-channel buck module to operate in the normal mode, when the voltage value of the DC voltage is set to be the preset minimum output voltage value and the preset minimum output voltage value is greater than the voltage value of the voltage requirement information.

4. The PD fast charging control circuit of claim 2, wherein the feedback voltage control module is configured to determine a target output voltage value of the isolated DC/DC conversion module according to the voltage requirement information in the control signal, and the isolated DC/DC conversion module is configured to reset conversion logic of DC conversion according to the target output voltage value to enable that the isolated DC/DC conversion module is able to output the target output voltage value according to the conversion logic.

5. The PD fast charging control circuit of claim 1, further comprising a DC input module, wherein the DC input module comprises an alternating current (AC) input filtering module, a rectification output module, and a power factor correction boost module, wherein
the AC input filtering module is configured to filter an AC that is inputted to the AC input filtering module;
the rectification output module is configured to rectify the AC that is filtered; and
the power factor correction boost module is configured to output an original DC voltage to the isolated DC/DC conversion module, wherein the original DC voltage is greater than a voltage outputted by the isolated DC/DC conversion module.

6. The PD fast charging control circuit of claim 2, further comprising a DC input module, wherein the DC input module comprises an alternating current (AC) input filtering module, a rectification output module, and a power factor correction boost module, wherein
the AC input filtering module is configured to filter an AC that is inputted to the AC input filtering module;
the rectification output module is configured to rectify the AC that is filtered; and
the power factor correction boost module is configured to output an original DC voltage to the isolated DC/DC conversion module, wherein the original DC voltage is greater than a voltage outputted by the isolated DC/DC conversion module.

7. The PD fast charging control circuit of claim 3, further comprising a DC input module, wherein the DC input module comprises an alternating current (AC) input filtering module, a rectification output module, and a power factor correction boost module, wherein
the AC input filtering module is configured to filter an AC that is inputted to the AC input filtering module;
the rectification output module is configured to rectify the AC that is filtered; and
the power factor correction boost module is configured to output an original DC voltage to the isolated DC/DC conversion module, wherein the original DC voltage is greater than a voltage outputted by the isolated DC/DC conversion module.

8. The PD fast charging control circuit of claim 4, further comprising a DC input module, wherein the DC input module comprises an alternating current (AC) input filtering module, a rectification output module, and a power factor correction boost module, wherein
the AC input filtering module is configured to filter an AC that is inputted to the AC input filtering module;
the rectification output module is configured to rectify the AC that is filtered; and
the power factor correction boost module is configured to output an original DC voltage to the isolated DC/DC conversion module, wherein the original DC voltage is greater than a voltage outputted by the isolated DC/DC conversion module.

9. A PD fast charging control method, comprising:
generating, by a pass-through mode control module, a control signal according to a charging load connected, sending, by the pass-through mode control module, the control signal to a feedback voltage control module, and determining, by the pass-through mode control module, an operating mode of a multi-channel buck module, the operating mode comprising a normal mode and a pass-through mode;
controlling, by the feedback voltage control module, a voltage value of a DC voltage outputted by an isolated direct current (DC) to direct current (DC/DC) conversion module according to the control signal received;
powering, by the isolated DC/DC conversion module, the charging load directly when an operating mode of the multi-channel buck module is the pass-through mode; and
bucking, by the multi-channel buck module, the DC voltage to power the charging load when the operating mode of the multi-channel buck module is the normal mode.

10. The PD fast charging control method of claim 9, wherein generating, by the pass-through mode control module, the control signal according to the charging load connected and sending, by the pass-through mode control module, the control signal to the feedback voltage control module comprises:
acquiring, by the pass-through mode control module, voltage requirement information of the charging load according to the charging load connected;
generating, by the pass-through mode control module, the control signal according to the voltage requirement information; and
sending, by the pass-through mode control module, the control signal to the feedback voltage control module.

11. The PD fast charging control method of claim 10, wherein controlling, by the feedback voltage control module, the voltage value of the DC voltage outputted by the isolated DC/DC conversion module according to the control signal received comprises:
controlling, by the feedback voltage control module, a DC conversion of the isolated DC/DC conversion module according to the voltage requirement information in the control signal to set the voltage value of the DC voltage outputted to be the same as a voltage value of the voltage requirement information or set the voltage value of the DC voltage to be a preset minimum output voltage value.

12. The PD fast charging control method of claim 10, wherein determining the operating mode of the multi-channel buck module comprises:
sending, by the pass-through mode control module, a first operating mode switching command to the multi-channel buck module to enable the multi-channel buck module to operate in the pass-through mode, when the voltage value of the DC voltage output is set to be the same as the voltage value of the voltage requirement information; and
sending, by the pass-through mode control module, a second operating mode switching command to the multi-channel buck module to enable the multi-channel buck module to operate in the normal mode, when the voltage value of the DC voltage is set to be the preset minimum output voltage value and the minimum output voltage value is greater than the voltage value of the voltage requirement information.

13. The PD fast charging control method of claim 11, wherein controlling, by the feedback voltage control module, the DC conversion of the isolated DC/DC conversion module according to the voltage requirement information in the control signal comprises:
determining, by the feedback voltage control module, a target output voltage value of the isolated DC/DC conversion module according to the voltage requirement information in the control signal, so that the isolated DC/DC conversion module resets conversion logic of DC conversion according to the target output voltage value to enable that the isolated DC/DC conversion module is able to output the target output voltage value according to the conversion logic.
